(19) United States
(12) Patent Application Publication
(10) Pub. No.: US 2009/0015785 A1
(43) Pub. Date: Jan. 15, 2009

(54) ADJUSTABLE CORRECTION FOR A VARIETY OF AMBIENT LIGHTING CONDITIONS

(76) Inventors: Ronald D. Blum, Roanoke, VA (US); Dwight P. Duston, Laguna Niguel, CA (US); William Kokonaski, Gig Harbor, WA (US); Joshua N. Haddock, Roanoke, VA (US); Anthony Van Heugten, Sarasota, FL (US)

Correspondence Address: Pearl Cohen Zedek Latzer, LLP, 1500 Broadway, 12th Floor, New York, NY, 10036, US

(21) Appl. No.: 12/135,587

(22) Filed: Jun. 9, 2008

Related U.S. Application Data
(60) Provisional application No. 60/929,041, filed on Jun. 8, 2007.

(51) Int. Cl. G02C 7/02

(52) U.S. Cl. 351/159

(57) ABSTRACT

A lens system is presented having a lens having an electro-active element, a sensor for sensing a change in ambient light, a controller in operative communication with the sensor, and a plurality of electrode rings electrically connected to the controller. The electrode rings may be concentric. The controller applies a voltage to the plurality of electrode rings when the sensor senses a change in ambient light. The application of voltage causes a change in the refractive index of the electro-active element for correcting a spherical aberration of the eye due to the sensed change in ambient light.

### CROSS REFERENCE TO RELATED APPLICATIONS

This application claims priority from and incorporates by reference in its entirety the following provisional application:

U.S. Ser. No. 60/929,041 filed on Jun. 8, 2007 and entitled “Ophthalmic Lens Having Adjustable Optical Power for a Variety of Ambient Lighting Conditions”.

### GOVERNMENT INTEREST STATEMENT

This invention was made in whole or in part with government support under Contract Number FA7014-07-C-0013, awarded by the U.S. Air Force, Office of the Surgeon General (AF/SG). The government may have certain rights in the invention.

### BACKGROUND OF THE INVENTION

A perfect lens focuses light to a single point on an optical axis of the lens. Spherical aberration is a deviation from the perfect focusing of light and occurs when light is focused to multiple points on the optical axis of the lens. Spherical aberration is an optical error that typically results in image imperfections, such as halos.

Spherical aberration is a fourth-order aberration (i.e., having an aberrated wavefront with a radial dependence that is mathematically represented by a fourth-order polynomial). However, spherical aberration is a zero-order aberration in meridional frequency (i.e., having an aberrated wavefront that is independent of azimuth angle, θ). Aberrations of the eye are commonly described mathematically as distorted optical wavefronts using a series of Zernike polynomials. The Zernike term, Z°₄, for spherical aberration of the eye is typically of the form:

Z°₄=ar²−br⁴ (1)

where r is the radial position within the pupil measured from the optical axis of the eye and a and b are constants. Spherical aberration of the eye can be positive or negative, and zero only at zero radius. FIG. 1 is a graph of equation (1) showing a wavefront exhibiting spherical aberration. It may be observed, using the aforementioned equation and figure, that spherical aberration is independent with respect to azimuth angle, θ, and thus, the aberration is azimuthally (i.e. rotationally) symmetric.

A variety of approaches are typically used to correct spherical aberration of the eye. One approach exploits the aforementioned azimuth symmetry of spherical aberration of the eye. In this approach, a lens for correcting spherical aberration is also azimuthally symmetric (e.g., circularly symmetric). Such a lens may have a radially symmetric optical power or phase variation that is equal and opposite (or nearly so) to that of the aberrated wavefront. The lens effectively cancels the spherical aberration of the eye. The spherical aberration correction of a lens can be positive (for canceling a negative spherical aberration of the eye) or negative (for canceling a positive spherical aberration of the eye). Although a lens for correcting a fixed amount of spherical aberration is known, other problems arise.

It is shown in equation (1) and FIG. 1 that the amount of spherical aberration of an eye depends on the radius of its pupil. Thus, as the pupil changes in size (e.g., in response to a change in ambient light), the amount of spherical aberration in the eye changes accordingly. This relationship is shown in FIGS. 2-5, which show side views of the focusing of light by a lens 95 of an eye having differently sized openings or pupils.

FIG. 2 shows the lens 95 having no pupil (i.e. a pupil dilated to its maximum diameter). The lens focuses light rays 50, 60, and 70, to multiple points 55, 65, and 75, respectively, on an optic axis of the lens. These multiple focal points are the result of spherical aberration of the natural lens of the eye. It is to be understood that FIGS. 2-5 show the focal points of a few discrete rays and that in an actual optical system there is a continuum of focal points between the focal point 55 and the focal point 75, inclusive of the focal point 65.

FIGS. 3-5 show the lens 95 having pupils 90, 85, and 80, respectively, with respectively decreasing diameter. FIGS. 3-5 show that as the pupil diameter decreases, the multiplicity of focus points (i.e., the degree and effects of spherical aberration) decreases as well. The lens of FIG. 3, having the pupil 90 with the relatively largest diameter, focuses the light rays 50, 60, and 70, to the largest number of distinct points 55, 65, and 75, respectively, on the optic axis of the lens. The lens of FIG. 4, having the pupil 85 with the relatively mid-range diameter, focuses the light rays to a relatively mid-range number of points 55 and 65 (between the numbers in FIGS. 3 and 5) on an optic axis of the eye lens. The lens of FIG. 5, having the pupil 80 with the relatively smallest diameter, focuses the light rays to the smallest number (1) point 55 on an optic axis of the eye lens.

It may be observed that as the diameter of the pupil changes, e.g., with changing ambient light, the amount of spherical aberration of the natural lens of the eye changes. While a conventional lens may correct for a fixed amount of spherical aberration, it cannot provide the necessary correction for changing spherical aberration in the eye.

There is therefore a great need in the art for providing a lens for correcting spherical aberration in the eye that changes in response to a change in ambient light or pupil diameter. Accordingly, there is now provided with this invention an improved lens for effectively overcoming the aforementioned difficulties and longstanding problems inherent in the art.

### SUMMARY OF THE INVENTION

In an embodiment of the invention, a lens system may include a lens having an electro-active element, a sensor for sensing a change in ambient light or pupil size, a controller in operative communication with the sensor, and a plurality of electrode rings electrically connected to the controller. The electrode rings are concentric. The controller applies a voltage to the plurality of electrode rings when the sensor senses a change in ambient light or pupil size. The application of voltage causes a change in the refractive index of the electro-active element for correcting a spherical aberration of the eye due to the sensed change in ambient light or pupil size.

In an embodiment of the invention, a lens system may include a lens having an electro-active element, a sensor for sensing a change in ambient light or pupil size, a controller in operative communication with the sensor, and a plurality of electrode rings electrically connected to the controller. The controller applies a voltage to the plurality of electrode rings when the sensor senses a change in ambient light or pupil size. The applied voltage is one of a plurality of voltage patterns predetermined to cause a change in the refractive index of the electro-active element. The change in the refractive index of the electro-active element causes the lens to refract light in a pattern for negating a spherical aberration of the eye due to the sensed ambient light or pupil size.

In an embodiment of the invention, a method for correcting spherical aberration of an eye, includes measuring spherical aberration of the eye for each of a plurality of different pupil sizes of the eye. The method further includes storing in memory a plurality of different values for voltages corresponding to the plurality of different pupil sizes. The method includes sensing a pupil size of the eye and retrieving from memory the one of the plurality of different values for voltages predetermined to correct the spherical aberration measured for the one of the plurality of different pupil sizes closest to the sensed pupil size. The method further includes applying voltages having the values retrieved from memory to the electrode rings of the lens.

In an embodiment of the invention, an ophthalmic lens has a sensor for detecting a change in ambient lighting and a controller. The controller adjusts an optical power of the ophthalmic lens based on the detected change in ambient lighting. The adjusted optical power of the ophthalmic lens substantially cancels a spherical aberration of an eye of a user of the ophthalmic lens.

### BRIEF DESCRIPTION OF THE DRAWINGS

Specific embodiments of the present invention will be described with reference to the following drawings, wherein:

FIG. 1 is a graph of a wavefront exhibiting spherical aberration as defined by equation (1).

FIGS. 2-5 show side views of the focusing of light rays by a lens of an eye, having openings of different diameters.

FIG. 6 shows a front view of a lens of the present invention for correcting spherical aberration of an eye.

FIG. 7 shows close-up views of the plurality of concentric electrode rings of FIG. 6.

FIG. 8A shows a front view of the lens of FIG. 6 with the electro-active region having a plurality of circular electrode rings that are concentric with the geometric center of the lens.

FIG. 8B shows a front view of the lens of FIG. 6 with the electro-active region having a plurality of circular electrode rings that are concentric with the fitting point of the lens.

FIGS. 8C and 8D show front views of the lenses of FIGS. 8A and 8B, respectively, having a progressive addition region, where at least a portion of the progressive addition region is in optical communication with the electro-active region.

FIGS. 8E and 8F show front views of the lenses of FIGS. 8C and 8D, respectively, having a second electro-active region for correcting low order aberrations, where at least a portion of the second electro-active region is in optical communication with the progressive addition region.

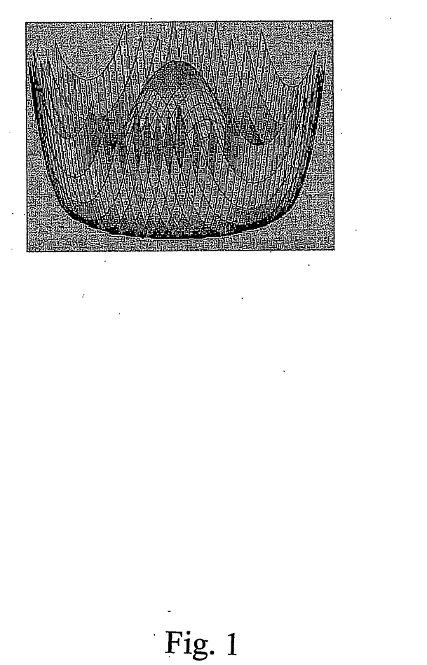

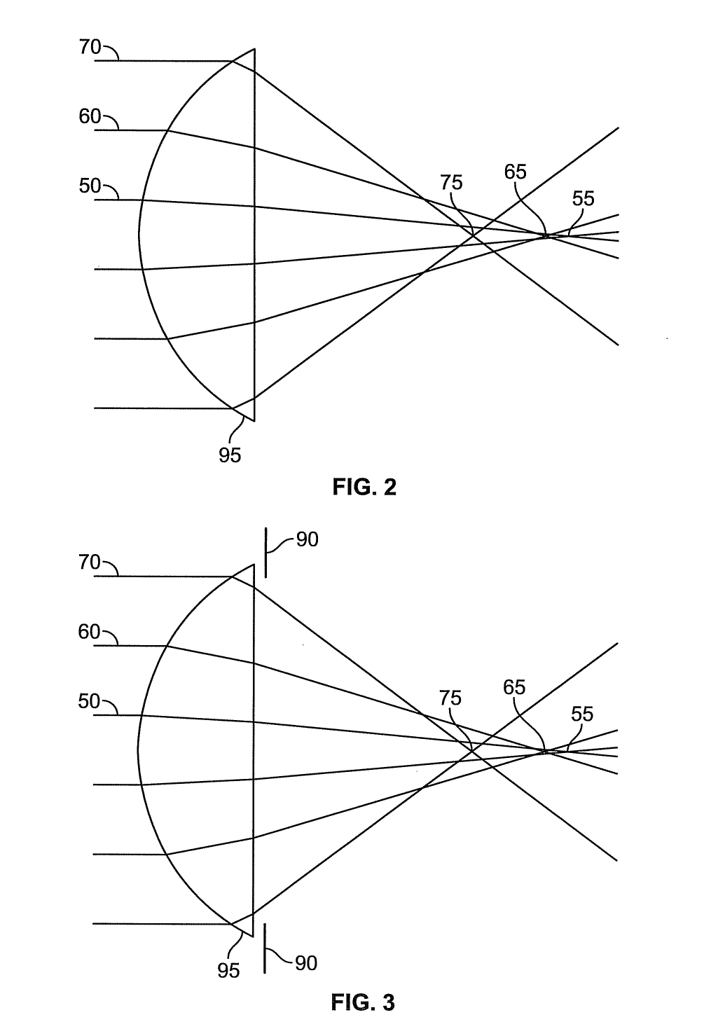

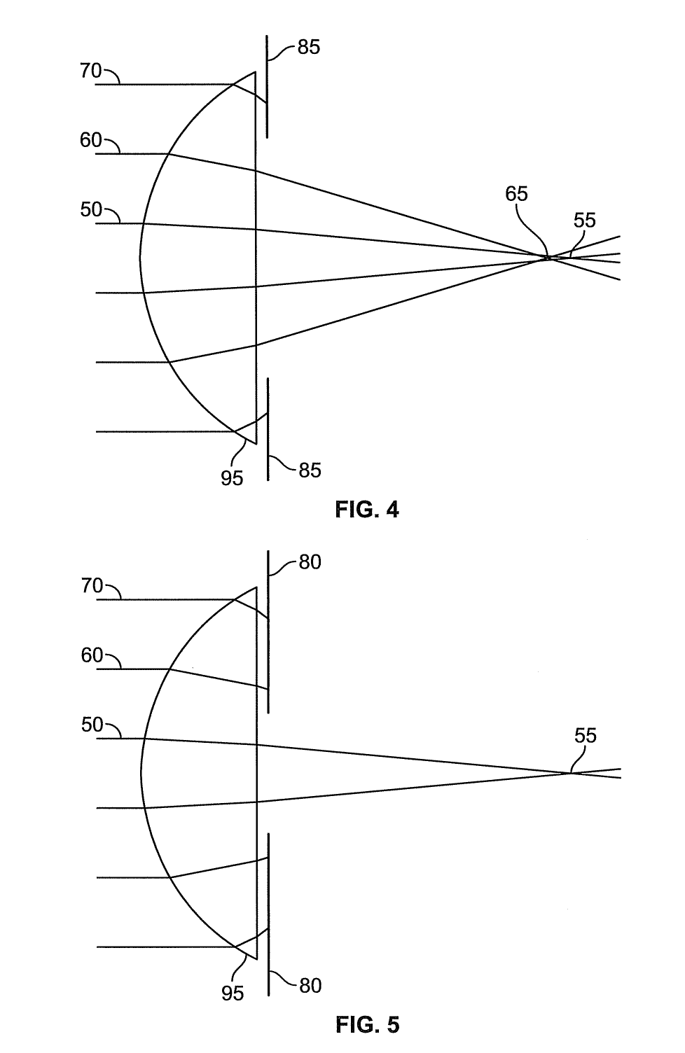

### DESCRIPTION OF THE PREFERRED EMBODIMENT

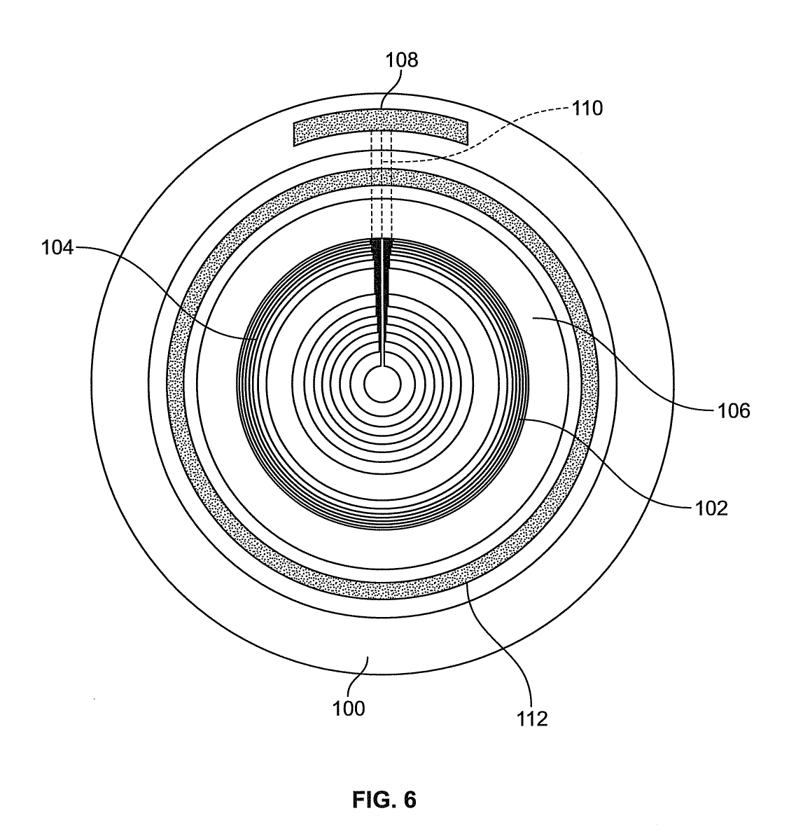

FIG. 6 shows a front view of a lens 100 having a sensor 106, a controller 108, and an electro-active region 102 with a plurality of concentric electrode rings 104 for correcting changing spherical aberration of an eye.

A lens system can include all of the components discussed herein, which can all be incorporated in a single lens, or alternatively, some of the components can be apart from the lens e.g., in a spectacle frame, a handheld device, or the user's apparel.

The sensor 106 senses a change in pupil size. In one approach, the sensor includes an imager in operative communication with a storage device and a processor. The imager is adapted for capturing images of the pupil over time. The images are typically stored in the storage device, although alternatively they may be sent directly as signals to the processor. The processor retrieves the images and compares contrast levels therebetween for identifying the dilation or constriction of the pupil over time. In another approach, the sensor includes a transmitter, a receiver, and a processor, all of which are operatively connected. The transmitter and the receiver are located internal or external to the eye. The transmitter transmits signals over time. The receiver receives the signals that reflect off of the iris of the eye (defining a moveable boundary of the pupil). The processor retrieves data associated with the reflected signals and calculates the trajectories of the reflected signal over time. The processor uses these trajectories to identify a change in the location of the iris over time. Accordingly, the processor identifies a dilation or constriction of the pupil over time. The sensor can transmit a report of this identification, e.g., via an input in the lens or in a spectacle frame that is not shown.

Alternatively, the sensor 106 may sense a change in ambient light. The sensor can be a photo-detector for detecting ambient light, such as a photovoltaic or photoconductive device. The sensor detects light internal or external to the eye.

Alternatively or in addition to the aforementioned designs, the sensor 106 includes a physical, manual, or capacitive switch (e.g., which switches between ‘on’ and ‘off’ when a user touches the nose bridge).

The controller 108 is in operative communication with the sensor 106. When the sensor senses a change, an action is triggered in the controller. The sensor and controller typically communicate via a direct electrical connection (e.g. wire(s)) or a transmit/receive device, such as an antenna or a microelectromechanical systems (MEMS) switch.

The controller 108 is electrically connected to the plurality of electrode rings 104. The controller may include drive electronics 110 and a power supply 112 such as a rechargeable battery. The controller applies voltage to each of the electrode rings sufficient for forming an electric field across the electro-active region and insufficient for the electrode rings to conduct with each other (i.e. shorting). The controller may apply either alternating current (AC) or direct current (DC) to the electrode rings.

The plurality of electrode rings 104 are concentric with the geometric center of the lens. The electrode rings extend radially from the center of the lens out to a radius between approximately 10 mm and approximately 20 mm. The electrode rings are, e.g., circular, although other geometries such as elliptical or polygonal geometries may alternatively be used. Although 16 electrode rings are shown, any number of rings may be used. The electrode rings are optically transparent. The electrode rings are composed of any of the known transparent conductive oxides (e.g., indium tin oxide (ITO)) or a conductive organic material (e.g., poly(3,4-ethylenedioxythiophene) poly(styrenesulfonate) (PEDOT:PSS) or carbon nano-tubes).

FIG. 7 shows close-up views of the plurality of electrode rings 104 of FIG. 6. Each of the electrode rings is shaped as a ring 114, interrupted by a pair of extending electrodes 116. Each pair of extending electrodes 116 extends for electrically connecting the rings 114 with the controller 108 and/or drive electronics 110. The extending electrodes 116 occupy a minimum space of the surface area of the lens for maximizing the surface area of the remaining rings 114 portion of the electrode rings 104, while having a sufficient amount of space therebetween to prevent the electrode rings from conducting (i.e. shorting). The thickness of each of the electrode rings is, e.g., less than 1 micron (μm), and preferably less than 0.1 μm. The width across the extending electrode rings is, e.g., less than 1 millimeter (mm) and preferably less than 150 μm. Other dimensions and/or numbers of electrode rings may alternatively be used depending on the optical effects sought to be achieved.

In an embodiment of the invention not shown in the figures, the plurality of electrode rings can be positioned on a first inner surface of the lens forming a first electrode layer. The lens preferably includes a second electrode layer. The second electrode layer is typically formed on a second inner surface of the lens positioned above or below the first electrode layer. There is a gap between the first and second electrode layers. The gap contains an electro-active material. The electro-active material includes liquid crystalline materials such as nematic liquid crystals or, preferably cholesteric liquid crystals. The electro-active material is preferably birefringent with the ability to alter the refractive index by application of a voltage. When the controller applies voltages to the electrode rings, an electric field is generated across the first and second electrode layers. This electrical field causes a change in the refractive index of the electro-active material (and thus, the lens).

Referring again to FIG. 6, the electrode rings 104 are always present. The electrode rings and the lens are always transparent. When voltage is applied to the electrode rings, the transparency of the lens is not altered. However, when voltage is applied to the electrode rings, electrical properties of the electrode rings are altered. The controller 108 applies voltages to the electrode rings 104 predetermined to cause a voltage pattern to negate spherical aberration.

In order to negate spherical aberration of the eye, the voltage pattern causes the refractive index of the lens 100 to generate a phase profile equal and opposite to that caused by the spherically aberrated lens of the eye. As previously described, a spherical aberration of the eye is related to the radius of the pupil by a fourth order polynomial, e.g., ar²−br⁴, where r is the radius of the pupil from the optical axis of the eye and a and b are constants. Accordingly, the refractive index profile of the lens for canceling such a spherical aberration generates a phase profile that negates that polynomial, e.g., −ar²+br⁴. Alternatively, the refractive index profile of the lens generates a phase profile that is an approximation of the phase profile required to negated the spherical aberration, e.g., +br⁴ (only the 4^{th} order term).

To achieve the refractive index profiles needed to generate the −ar²+br⁴ or +br⁴ phase profiles, the controller applies voltages that cause a radial gradient in voltage across the electro-active region. The radial gradient in voltage changes the refractive index of the electro-active material, e.g., to generate the −ar²+br⁴ or +br⁴ phase profiles. The lens thereby effectively cancels the (i.e., fourth order) spherical aberration of the eye as it varies along the radius of the pupil.

Although this correction is proper for canceling the aforementioned spherical aberration, as the radius of the pupil changes (in response to a change ambient light), this spherical aberration also changes. Thus, a new correction is needed. A change in the diameter of a pupil causes the spherical aberration, ar²−br⁴, to change by the constant term(s), a and/or b. In an example, a first spherical aberration of the eye is a₁r²−b₁r⁴ for a first pupil diameter. In this example, a second spherical aberration of the eye is a₂r²−b₂r⁴ for a second pupil diameter. Thus, when the sensor senses a change in the eye from the first to the second pupil diameter, the controller switches states. For example, the controller switches from applying voltages predetermined to generate a refractive index state causing a phase profile of −a₁r²+b₁r⁴ to voltages predetermined to generate a refractive index state causing a phase profile of −a₂r²+b₂r⁴. The lens having a phase profile of −a₂r²+b₂r⁴ thereby cancels the new second spherical aberration of the eye a₂r²−b₂r⁴. Thus, the lens provides the proper correction for changing spherical aberration of the eye.

It is known that pupil size, and thus, spherical aberration, changes continuously and with infinite variation. However, typically, the controller 108 applies a finite number of different voltages to the electrode rings 104. The application of these voltages cause a finite number of voltage patterns, which, in turn, negate a finite number of different configurations of spherical aberration. As the number of distinct voltages increases, the number of different spherical aberration corrections likewise increases and thus, the accuracy (on average) of the overall lens correction is improved.

As opposed to the controller applying a finite number of different voltages to the electrode rings 104, the controller 108 can apply a continuous variation of voltages to the electrode rings 104 for providing infinite different corrections for negating the continuous variation in spherical aberration.

A change in ambient light typically causes a change in pupil size, which in turn causes the aforementioned change in spherical aberration of the eye. Therefore, a spherical aberration caused by a sensed pupil size may accordingly be caused by a sensed amount of ambient light.

The change in pupil size and the change in ambient light are inversely (but not necessarily linearly) proportional. In one example, the degree (i.e., absolute value) of spherical aberration correction typically increases when the sensor senses an increase in pupil size. Accordingly, the degree of spherical aberration correction typically increases when the sensor senses a decrease in ambient light. In another example, the degree of spherical aberration correction typically decreases when the sensor senses a decrease in pupil size. Accordingly, the degree of spherical aberration correction typically decreases when the sensor senses an increase in ambient light.

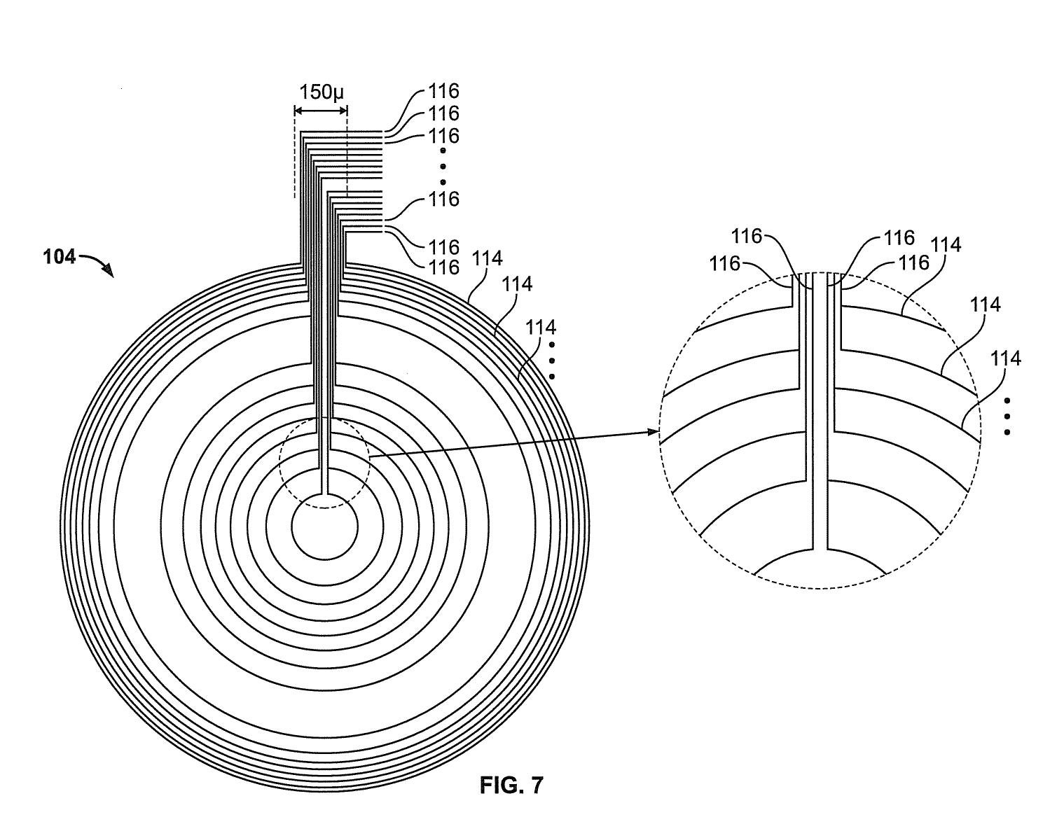

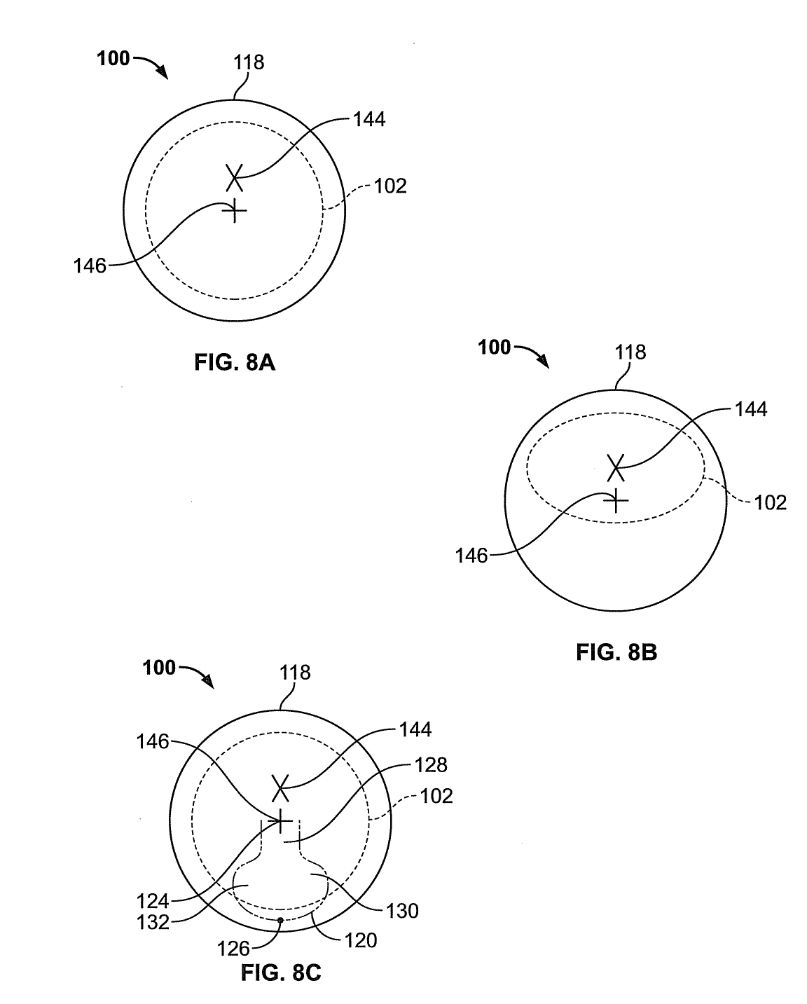

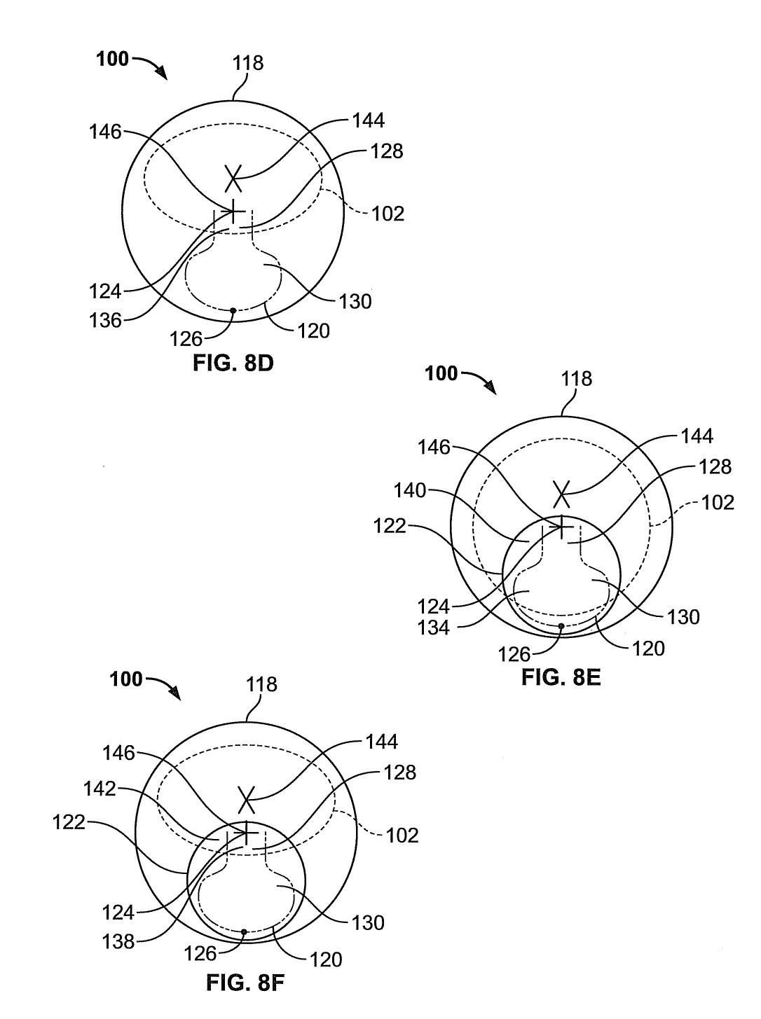

FIGS. 8A-8F show front views of the lens 100 of FIG. 6 having a fixed lens region 118 in optical communication with the electro-active region 102 for correcting spherical aberration.

The fixed lens region 118 provides a fixed optical power to the lens. The fixed lens region extends radially to occupy the full view of the lens. Alternatively, the fixed lens region is spaced from at least a portion of the peripheral edge.

When voltage is applied to the electro-active region 102, the electro-active region provides additional optical power to the lens for correcting a spherical aberration of the eye. When voltage is applied to the electro-active region 102, the electro-active region adds an optical power varying along the radius of the lens, e.g., in a range of from 0.12 diopters (D) to 1.00 D, and preferably in a range of from 0.25 D to 0.50 D. Other optical powers may alternatively be used to achieve a different optical effect.

Typically, when no electrical power is applied to the electro-active region 102, the electro-active region typically provides no additional optical power to the lens. For example, when no voltage is applied to the electro-active region, the refractive index thereof matches the refractive index of the fixed lens region, and thus, does not alter the optical properties thereof. The electro-active region 102 typically extends radially towards at least a portion of the peripheral edge of the lens or, alternatively, is spaced from the peripheral edge.

The lens 100 has a geometric center 146. The lens 100 has a fitting point 144. The fitting point of the lens is a reference point that represents the approximate location of the wearer's pupil when looking straight ahead through the lens. The fitting point is usually, but not always, located 2-5 mm vertically above the geometric center of the lens. This point or cross is typically marked on the lens surface such that it can provide an easy reference point for measuring and/or double-checking the fitting of the lens relative to the pupil of the wearer. The mark is easily removed upon the dispensing of the lens to the patient/wearer.

In FIGS. 8A, 8C, and 8E, the electro-active region 102 is circularly shaped. The electro-active region is formed from the plurality of electrode rings 104 that are concentric with the geometric center 146 of the lens. The electrode rings are circularly shaped. The diameter of the largest of the electrode rings is from approximately 10 mm to approximately 20 mm.

In FIGS. 8B, 8D, and 8F, the electro-active region 102 is elliptically shaped. The electro-active region is formed from the plurality of electrode rings 104 that are concentric with the fitting point 144 of the lens. The electrode rings 104 are circularly shaped and are cropped to form the elliptically shaped electro-active region 102. The large axis of the largest of the electro-active region is from approximately 10 mm to approximately 20 mm. The small axis is from approximately 5 mm to approximately 10 mm. Alternatively, the electrode rings 104 may be cropped in other designs to form an electro-active region having any shape.

In FIGS. 8C-8F, the lens 100 includes a progressive addition region 120. The progressive addition region provides a gradient of continuously increasing positive optical power that extends from a starting point 124 of a far distance viewing zone 128 (e.g., in the top-most half of the lens) of the lens to an ending point 126 of a near distance viewing zone 130 (e.g., in the lower portion of the lens) of the lens. This progression of optical power generally starts at approximately the fitting point of the lens and continues until the full add power is realized in the near distance viewing zone. Typically, the optical power then plateaus. Typically, the progressive addition region has a variable curvature surface on one or both outer surfaces of the lens (not shown) that is shaped to create this progression of optical power.

The lenses of FIGS. 8C and 8E have regions 132 and 134, respectively, where the electro-active region 102 is in optical communication with at least a portion, and preferably most, of the progressive addition region 120. For example, the electro-active region is in optical communication with the far distance viewing zone 128 and the near distance viewing zone 130 of the progressive addition region.

The lenses of FIGS. 8D and 8F have regions 136 and 138, respectively, where the electro-active region 102 is in optical communication with at least a portion, and preferably a small portion, of the progressive addition region 120. For example, the electro-active region is in optical communication with only the far distance viewing zone 128 of the progressive addition region.

In FIGS. 8C-8F, the electro-active region 102 typically provides the spherical aberration correction and the progressive addition region 120 provides the remaining optical power to provide the wearer's total optical power correction.

In FIGS. 8E and 8F, the lens 100 further includes a multi-focal optic 122. The multi-focal optic is typically in optical communication with some, and preferably all, of the progressive addition region 120. The multi-focal optic provides optical power replacing, in part, power provided by the progressive addition region. By decreasing the power of the progressive addition region, the optical aberration associated therewith likewise decrease. The multi-focal optic may be an electro-active optic or a fixed optic.

The lens of FIG. 8E has a region 140 where the multi-focal optic is in optical communication with a portion, and preferably most, of the electro-active region 102. For example, the multi-focal optic is in optical communication with the far distance viewing zone 128 and the near distance viewing zone 130 of the progressive addition region.

The lens of FIG. 8F has a region 142 where the multi-focal optic is in optical communication with a portion, and preferably a small portion, of the electro-active region 102. For example, the multi-focal optic is in optical communication with only the far distance viewing zone 128 of the progressive addition region.

In an embodiment not shown in the figures, the lens of the present invention may be for example, an intra-ocular lens, a corneal in-lay, a corneal on-lay, a contact lens, and/or a spectacle lens. The correction region for spherical aberration is typically located along the optical axis of the lens. When the lens is a contact lens, intra-ocular lens, corneal in-lay or a corneal on-lay, the optical axis of the lens stays positioned with respect to the optical axis of the eye. Thus, the lens corrects the spherical aberration of the eye regardless of the rotation of the eye.

This is not the case when the lens is positioned in a spectacle frame having a stationary optical axis. Typically, the lens negates the spherical aberration of the eye when the optical axis of the eye is aligned with the optical axis of the lens. Thus, when the eye rotates with respect to the optical axis of the lens, the correction applied to the eye is improper. To overcome this problem, in one approach, the spectacle frame includes a gaze detector that detects the direction of a wearer's gaze. Since the electro-active region provides the spherical aberration correction in the lens, when a user's gaze is directed outside of the electro-active region, the lens cannot provide proper spherical aberration correction. Thus, when the gaze detector detects a deviation of gaze direction away from the optical axis of the lens, the electro-active region of the lens is turned off. Alternatively, the spectacle frame includes an eye-tracking device for detecting the direction of the wearer's gaze. In yet another approach, the electro-active region may be extended (e.g., using pixilated electrodes) to provide spherical aberration correction near the periphery of the lens.

In an embodiment of the present invention, the fixed lens region provides an optical power that varies (increasing or decreasing) radially from the center of the lens. For example, a first region of the fixed lens region extending 3 mm from the center of the lens provides zero D of optical power, a second region of the fixed lens region extending from 3 mm to 4.5 mm from the center of the lens provides −1.00 D of optical power, and a third region of the fixed lens region extending from 4.5 mm to 6 mm from the center of the lens provides −2.00 D of optical power. The electro-active region is a flat continuous electrode layer. The electro-active region adds a uniform spherical power across the full field of the electro-active region. The combined varying optical power of the fixed lens region and the uniform spherical power of the electro-active region is provided to negate a spherical aberration in the eye. For example, when the pupil radius is less than 3 mm, and constricted to the first region, the electro-active region provides no spherical power. When the pupil radius is 4 mm (the pupil covers the first region and partially overlaps the second region) the uniform spherical power of the electro-active region is in a range of from zero D of the first region to −1.00 D of the second region, and preferably an average therebetween of −0.50 D. When the pupil radius is 5 mm (the pupil covers the first and second regions and partially overlaps the third region), the uniform spherical power of the electro-active region is in a range of from −1.00 D of the second region to −2.00 D of the third region, and preferably an average therebetween of −1.00 D. Although three regions and optical powers and specific dimensions thereof are described, alternatively any other number of regions, optical powers and dimensions (up to the maximum opening size of the pupil) may be used according to the present invention.

In a further embodiment of the present invention, the spherical aberration of the natural lens of an eye may be measured by an aberrometer (i.e., a wavefront analyzer) for a plurality of pupil sizes (i.e., in a plurality of ambient lighting conditions). The aberrometer determines a plurality of different lens corrections, each predetermined to negate the measured spherical aberration for one of the plurality of pupil sizes. The aberrometer determines a plurality of different values for voltages corresponding to the different pupil sizes. The plurality of different voltages are stored in a memory of the controller. Instructions to apply these voltages to the electrode rings when the sensor senses the corresponding lighting condition are also stored in a memory of the controller. During operation of the lens, when the sensor senses a pupil size (e.g., or ambient lighting condition), the controller retrieves from memory the value corresponding to the one of the plurality of pupil sizes closest to the sensed pupil size. This voltage value is predetermined to correct the spherical aberration measured for the one of the different pupil sizes closest to the sensed pupil size. The controller applies the voltages having the values retrieved from memory to the electrode rings of the lens. The applied voltages cause voltage patterns to generate the lens correction for negating the measured spherical aberration for the pupil size closest to the sensed pupil size.

In another embodiment, the electro-active region can be patterned by pixilated electrodes. Pixilated electrodes are individually addressable regardless of the size, shape, and arrangement of the electrodes. Furthermore, because the electrodes are individually addressable, any arbitrary pattern of voltages may be applied to the electrodes. For example, pixilated electrodes may be squares or rectangles arranged in a Cartesian array or hexagons arranged in a hexagonal array. Pixilated electrodes need not be regular shapes that fit to a grid. For example, pixilated electrodes may be concentric rings if every ring is individually addressable.

The fixed lens region may include any lens, e.g., refractive, diffractive, surface relief diffractive, spherical, cylindrical, aspherical, plano, convex, concave, single-focus, multi-focus, bifocal, trifocal, progressive addition, near distance, far distance, intermediate distance, or any combination thereof depending on the optical effects sought to be achieved. The fixed lens region and the electro-active lens region can provide any combination of spherical, cylindrical, and aspherical power depending on the optical effects sought to be achieved.

Although the present invention describes correcting spherical aberration, it may be appreciated by those skilled in the art that the present invention can be used to correct for any higher order aberration of the eye, including non-spherical higher order aberrations. Additionally, the present invention can be used to correct for any lower order aberrations of the eye such as near-sightedness, farsightedness, presbyopia, and astigmatism. The correction may be created by the electro-active region, the fixed lens region, the progressive addition region, the multi-focal optic, or by a combination thereof.

Although the present invention describes correcting spherical aberration, it may be appreciated by those skilled in the art that, with correction, some spherical aberration of the eye typically still exists. The electrode rings of the lens typically cause a voltage pattern to approximately (and not exactly) negate of spherical aberration of the eye. Thus, the spherical aberration of the eye may be reduced, to almost, but not necessarily equal to, zero.

In some cases, pupil size is a measure of the overall opening of the lens of the eye to ambient light and includes a measure of squinting and/or blinking of the eye lid.

What is claimed is:

1. A lens system, comprising:
(a) a lens having an electro-active element;
(b) a sensor for sensing a change in ambient light;
(c) a controller in operative communication with the sensor; and
(d) a plurality of electrode rings electrically connected to the controller, wherein the electrode rings are concentric, and
wherein the controller applies a voltage to the plurality of electrode rings when the sensor senses a change in ambient light, wherein the application of voltage causes a change in the refractive index of the electro-active element for correcting a spherical aberration of the eye due to the sensed change in ambient light.

2. The lens system of claim 1, wherein the changed refractive index of the electro-active element causes the lens to cancel the spherical aberration of the eye due to the sensed change in ambient light.

3. The lens system of claim 1, wherein the refractive index of the electro-active element is changed between a first state and a second state, wherein the first refractive index state corrects a spherical aberration due to relatively low ambient light and the second refractive index state corrects a spherical aberration due to relatively high ambient light.

4. The lens system of claim 1, comprising increasing the spherical aberration correction when the sensor senses a decrease in ambient light.

5. The lens system of claim 1, comprising decreasing the spherical aberration correction when the sensor senses an increase in ambient light.

6. The lens system of claim 1, wherein the electrode rings are concentric with the geometric center of the lens.

7. The lens system of claim 1, wherein the electrode rings are concentric with the fitting point of the lens.

8. The lens system of claim 1, wherein the lens provides a spherical optical power.

9. The lens system of claim 1, wherein the lens further corrects a lower order aberration of the eye.

10. The lens system of claim 1, wherein the lens further corrects a higher order aberration of the eye that is non-spherical.

11. A lens system, comprising:
(a) a lens having an electro-active element;
(b) a sensor for sensing ambient light;
(c) a controller in operative communication with the sensor; and
(d) a plurality of electrode rings electrically connected to the controller, wherein the controller applies a voltage to the plurality of electrode rings when the sensor senses a change in ambient light, wherein the applied voltage is one of a plurality of voltage patterns predetermined to cause a change in the refractive index of the electro-active element, wherein the change in the refractive index of the electro-active element causes the lens to refract light in a pattern for negating a spherical aberration of the eye due to the sensed ambient light.

12. The lens system of claim 11, wherein the refractive index of the electro-active element is changed between a first state and a second state, wherein the first refractive index state negates a spherical aberration due to relatively low ambient light and the second refractive index state negates a spherical aberration due to relatively high ambient light.

13. The lens system of claim 11, comprising negating a relatively larger spherical aberration when the sensor senses a decrease in ambient light.

14. The lens system of claim 11, comprising negating a relatively smaller spherical aberration when the sensor senses an increase in ambient light.

15. A lens system, comprising:
(a) a lens having an electro-active element;
(b) a sensor for sensing a change in pupil size;
(c) a controller in operative communication with the sensor; and
(d) a plurality of electrode rings electrically connected to the controller, wherein the electrode rings are concentric, and
wherein the controller applies a voltage to the plurality of electrode rings when the sensor senses a change in pupil size, wherein the application of voltage causes a change in the refractive index of the electro-active element for correcting a spherical aberration of the eye corresponding to the sensed change in pupil size.

16. The lens system of claim 15, wherein the changed refractive index of the electro-active element cancels the spherical aberration of the eye due to the sensed change in pupil size.

17. The lens system of claim 15, wherein the refractive index of the electro-active element is changed between a first state and a second state, wherein the first refractive index state corrects a spherical aberration due to relatively large pupil size and the second refractive index state corrects a spherical aberration due to relatively small pupil size.

18. The lens system of claim 15, comprising increasing the spherical aberration correction when the sensor senses an increase in pupil size.

19. The lens system of claim 15, comprising decreasing the spherical aberration correction when the sensor senses a decrease in pupil size.

20. The lens system of claim 15, wherein the electrode rings are concentric with the geometric center of the lens.

21. The lens system of claim 15, wherein the electrode rings are concentric with the fitting point of the lens.

22. A lens system, comprising:
(a) a lens having an electro-active element;
(b) a sensor for sensing pupil size;
(c) a controller in operative communication with the sensor; and
(d) a plurality of electrode rings electrically connected to the controller, wherein the controller applies a voltage to the plurality of electrode rings when the sensor senses a change in pupil size, wherein the applied voltage is one of a plurality of voltage patterns predetermined to cause a change in the refractive index of the electro-active element, wherein the change in the refractive index of the electro-active element causes the lens to refract light in a pattern for negating a spherical aberration of the eye due to the sensed pupil size.

23. The lens system of claim 22, wherein the refractive index of the electro-active element is changed between a first state and a second state, wherein the first refractive index state negates a spherical aberration due to relatively large pupil size and the second refractive index state negates a spherical aberration due to relatively small pupil size.

24. The lens system of claim 22, comprising negating a relatively larger spherical aberration when the sensor senses an increase in pupil size.

25. The lens system of claim 22, comprising negating a relatively smaller spherical aberration when the sensor senses a decrease in pupil size.

26. A method for correcting spherical aberration of an eye, comprising:
(a) measuring spherical aberration of the eye for each of a plurality of different pupil sizes of the eye;
(b) storing in memory a plurality of different values for voltages corresponding to the plurality of different pupil sizes;
(c) sensing a pupil size of the eye;
(c) retrieving from memory the one of the plurality of different values for voltages predetermined to correct the spherical aberration measured for the one of the plurality of different pupil sizes closest to the sensed pupil size; and
(d) applying voltages having the values retrieved from memory to the electrode rings of the lens.

27. An ophthalmic lens, comprising:
(a) a sensor for detecting a change in ambient lighting; and
(b) a controller, wherein the controller adjusts an optical power of the ophthalmic lens based on the detected change in ambient lighting and wherein the adjusted optical power of the ophthalmic lens substantially cancels a spherical aberration of an eye of a user of the ophthalmic lens.
